(19) United States
(12) Patent Application Publication
(10) Pub. No.: US 2008/0066356 A1
(43) Pub. Date: Mar. 20, 2008

(54) Luminous Displays

(76) Inventors: David C. Miller, Tampa, FL (US); Eric Bretschneider, Clarkston, MI (US); Timothy E. Safford, Bradenton, FL (US); David M. Chism, Bradenton, FL (US); Randolph Scott Beeman, Sarasota, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/573,330

(22) PCT Filed: Aug. 5, 2005
(86) PCT No.: PCT/US05/28038

§ 371 Date: Sep. 26, 2007

Related U.S. Application Data
(60) Provisional application No. 60/599,672, filed on Aug. 6, 2004.

(51) Int. Cl. G09F 13/18

(52) U.S. Cl. 40/546

(57) ABSTRACT

Side lighting of a transparent panel with etched features to scatter light towards an observer provides a physically robust alternative to neon tube technology. In particular, a number of advantages can be realized by using chip on board (COB) LED technology. COB LEDs offer particular advantages in allowing use of low operating voltages as well as control over the intensity and color of the displays. Other advantages are realized by aligning two or more panels, each with a portion of a design, and independently varying the color or intensity of light.

### TECHNICAL FIELD

This invention relates to the field of luminous displays and signs, particularly colored signs.

### BACKGROUND

Luminous displays or signs are used for advertising, promotional and identification purposes, for example, by many businesses to help market or sell a product or service. Colors in a single display are used to draw attention to a display and thus improve its effectiveness. Multiple colors are used to draw added attention to a display. Conventionally, luminous displays consist of lighted neon tubes, and different colors are created by using a variety of differently colored neon tubes. Colors are created by use of various gas compositions, phosphor coatings or filtering media. Use of neon tube technology only allows selection of colors prior to the assembly of a display. Once created, the colors in a luminous display cannot be changed.

Additional drawbacks of neon tube technology arise due to the fragile nature of the glass tubes. These tubes are thin-walled glass and require careful handling to prevent breakage during manufacture, transport and installation. The use of neon tubes also requires high operating voltages that present significant safety hazards. High operating voltages prohibits use of neon tube technology in close proximity to food items or in high moisture environments such as refrigerated display cases.

### SUMMARY

An aspect of this invention is a luminous display comprising a panel of a transparent medium such as glass having etched therein a design, and a low-voltage light source, not more than 24 volts, preferably 12 volts or below, disposed to inject light into and across the panel through an edge thereof, whereby the etched lines or areas scatter light and render the design visible as a lighted display.

Another aspect of this invention is such a luminous display comprising multiple spaced apart, stacked panels that each include a portion of the overall lighted design and that are separately lighted, optionally with light of different colors. By stacking two or more panels together, each with a different portion of a design, an aesthetically pleasing dimensional affect can be achieved that enhances the attractiveness of a display.

A further aspect of this invention is such a luminous display that utilizes LEDs, preferably COB LEDs as the light source or light sources.

Yet another aspect of this invention is including in any of the foregoing displays a programmed, optionally user programmable, controller to vary over time the overall light intensity, whether the light is on or off, duration of on and off times, the light color, or a combination of those features.

Yet another aspect of this invention is increasing the luminosity of the design by including reflectors on the light sources, and by covering panel edges with reflective film, or both.

The present invention includes luminous displays or signs that eliminate the need for neon tubes and for high operating voltages. Luminous displays of this invention mimic the appearance of neon tube luminous displays. They include at least one panel made of transparent medium such as acrylic polymer or glass. A design is etched into a surface of the transparent medium. The etched design is then transformed into a luminous display by injecting light into at least one edge of a panel of transparent medium. In preferred embodiments a large portion or substantially all of the light is confined to the interior or the panel by total internal reflection. Light that interacts with the etched areas scatters in all directions and produces a visual impression similar to a lighted tube.

This invention avoids the use of fragile materials such as thin neon tubes and allows the creation of a physically robust luminous display. In preferred embodiments, the light source is made up of a multitude of high emitting diodes (“LEDs”) arranged to inject light efficiently into a transparent panel. In LED embodiments it is preferable to use LEDs of more than one wavelength, more preferably with a controller that adjusts the relative output of each color of LED, whereby the color of the luminous display can be varied. By using a minimum of three different colors of LEDs, such as blue, green and red, the color of the luminous display can be changed during use from one color to another by a suitably programmed or programmable controller. Transitions between colors may be instantaneous or gradual.

In certain embodiments, two or more transparent panels are used, each with a different design, or a different portion of a single design. Two or more transparent panels can be stacked, that is, assembled in close proximity with a small space between adjacent panels. An independent light source is attached to each panel. A small space between adjacent panels provides a change in refractive index that prevents light transmission between panels. By independently controlling the light sources for the panels, different portions of the luminous displays may be lighted with different colors and may be varied independently to draw more attention to a display.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an exploded view of a luminous display according to this invention comprising a stack of three panels with independently controlled light sources.

### DETAILED DESCRIPTION

Luminous displays according to this invention comprise one or more panels of transparent medium, for example, a pane of glass, acrylic or other transparent polymeric material.

Panels suitable for use in this invention have two parallel major surfaces and one or more minor surfaces. The panels typically are flat, with major planar surfaces having a geometric shape such as rectangular, triangular, oval or circular, although any desired shape may be utilized. Most commonly panels will be rectangular with four minor surfaces, or edges (a circular panel has one continuous edge surface). While panels are typically flat, some curvature is permitted, as long as light injected through an edge is not scattered as it traverses the unetched panel. For example, a panel may have the shape of a portion of the curved surface of a cylinder.

A design is etched into at least one major surface of a panel, preferably as a series of lines that when illuminated have the general appearance of thin lighted tubes. Designs may be alphanumeric, pictorial or graphical. They may be etched into a panel surface utilizing any convenient mechanical, chemical or thermal etching process and apparatus. For special effects some or all etched lines may include phosphorescent and/or fluorescent coatings, in which event ultraviolet light sources will be used where appropriate.

At least one light source is utilized to inject light into the panel's transparent medium through at least one edge in a direction parallel to the panel's major surfaces. The injected light travels through the transparent medium of the panel, in which it is contained. In preferred embodiments panel edges or edge regions not utilized for light injection are coated with a reflective film to prevent light from escaping and to aid in uniform illumination of etched features that scatter light. Suitable reflective coatings that act as specular reflectors include silver coatings and metalized plastic films such as aluminized Mylar® polyester film (DuPont, Wilmington, Del., U.S.A.) and Magic Mirror™ polymeric film (3M Co., St. Paul, Minn., U.S.A.) Diffuse reflecting materials may be used, but they are less efficient in aiding illumination of etched portions and are not preferred for that reason.

Lines etched into a panel's transparent medium through an edge, or minor surface, of the panel scatter light in all directions. When light traversing the panel from edge to edge encounters an etched line, scattering causes etched lines to “light up” and appear to glow, in contrast to the surrounding unetched portions of the panel.

Light sources may be any compact light source including incandescent tube bulbs, fluorescent lights, cold cathode fluorescent lights, EL strips, LEDs, and combinations of the foregoing. Preferably high voltages greater than 24 volts are avoided. The light source or light sources are disposed so as to inject light into one or more panel edges parallel to the major surfaces of the panel. A light source or sources may be disposed along a portion of one edge of a panel, along the entire length of one edge of a panel, or along portions or entire lengths or multiple edges of a panel. Preferred embodiments utilize LEDs as light sources. For tunable colors and color-changing displays we prefer as the light source or light sources linear chip-on-board (COB) assemblies of different color LEDS, most preferably three or more different color LEDs. COB technology permits tight packing density of LED chips and, therefore, a high luminous flux per linear length compared to other arrangements. In particular, it has been found that a close pitch (spacing between LEDs) must be used to provide uniform color mixing. This is especially critical if relative intensities of the different color LEDs are being adjusted for white light. A pitch spacing of less than 0.2 inches (0.5 cm) has been found to be particular effective in providing uniform color mixing.

Whatever the light source or sources, lighting efficiency can be increased by incorporating a reflector around the light source to direct substantially all of the light into a panel in such a maimer that it is confined in the panel by total internal reflection. Any material that acts as a predominantly specular reflector may be used as the inner surface of a reflector, for example, extended specular reflector (ESR) films or aluminized polyester film. Reflective surfaces may be of parabolic or conical in shape or cross section to aid in focusing the light. Optionally, refractive optics may also be used to focus light into the panel. Index matching, that is, matching the refractive index of the light source and the panel's transparent medium, assists in improving the efficiency of light injection, thereby allowing a the display to operate at an overall higher luminous intensity.

Embodiments of the invention include two or more independently lighted stacked panels each of which contains a portion of the luminous display's information or graphics. The panels may be lighted with differently colored light (in this case considering white as a color). Alternatively or in addition, the panels may be individually controlled to flash on and off, to dim and brighten, or to change color, or any combination of such variations to achieve a desired visual effect. An additional benefit of utilizing two or more panels, each containing a portion of the overall design is the creation of an aesthetically pleasing dimensional affect. This dimensionality can not be achieved with traditional technology and serves to enhance the attractiveness of a display.

Multiple panels are kept optically separate by means of difference in refractive index. One way to do this is to utilize different transparent media having different indices of refraction for any two adjacent panels in a stack, as is known for use in fiber optic cables. Our preferred construction utilizes a gap between adjacent panels. Most preferably the gap is filled with air, in which case there need not be a gas-tight seal enclosing the gap, although it could be filled with a selected gas or it could be evacuated.

Control of the COB LED light sources is preferably accomplished using a power supply with a microprocessor that is configured to allow the user to choose a variety of lighting effects including: the overall light intensity, whether the light is on or off, duration of on and off times, the light color, or a combination of those features. The controller may be preprogrammed with these effects or may be configured to allow the user to manually adjust any or all of these features. A variety of control schemes known in the art may be used to control the intensity of the LEDs including, but not limited to current control, voltage control, pulse width modulation and pulse amplitude modulation. By varying the intensity of different color LEDs, the output color may be adjusted. For example, controlling the relative intensity of green and red LEDs will allow selection of colors ranging from red to orange to yellow to green.

With the exception of red and orange, the colors of light produced by neon tubes exhibit poor saturation. Neon tubes are not capable of producing highly saturated yellow, green, blue or purple colors. This significantly limits the gamut of colors that may be produced using neon tubes. Due to the near monochromatic nature of LED light, significantly higher color saturation may be achieved than is possible using neon tube technology. This will in turn allow production of a much broader gamut of colors.

### EXAMPLE

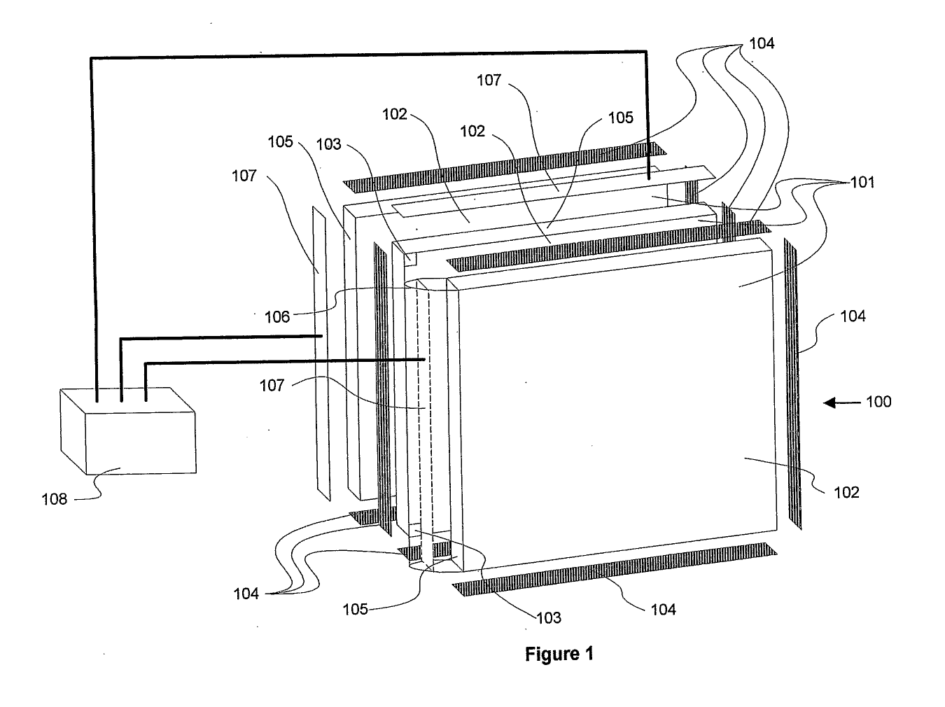

FIG. 1 illustrates an apparatus according to this invention. FIG. 1 shows a stacked panel display 100 that includes three flat, rectangularly shaped panels 101 of a transparent medium, in this case glass. Each panel includes a major front surface 102 and a major rear surface (not shown). Alphanumeric and/or graphical display content (not shown) may be etched into the front or rear or both major surfaces of each panel. Thin spacer blocks or strips 103 are applied to two panels to provide air gaps between adjacent panels. The exact material used for the spacer blocks is not a critical aspect of the invention. It is important that the spacer blocks be of uniform thickness so that the panels are essentially parallel to each other. The spacer blocks preferably are between 0.001 inches (0.0025 cm) and 0.25 inches (0.635 cm) thick, although much larger thicknesses may be used. Reflector film strips 104 are disposed along three minor sides, or edges, of each panel, leaving one edge 105 for light injection. In FIG. 1 the exposed edges 105 for the front and rear panels are on the left edges of the panels, whereas the exposed edge 105 for the middle panel is on the top of the panel. Extending along each exposed panel edge is a reflector housing 106 enclosing a lighting strip 107. For clarity of illustration the reflector housing 106 is shown in FIG. 1 only for the front panel. The inner reflective surface of housing 106 is parabolic in cross section. Each lighting strip 107 is wired to electronic controller 108. The COB LED strips in the example contain a mixture of blue, green and red LEDs. The LEDs are powered using a control circuit that utilizes pulse width modulation to control the intensity of each color LED.

A number of embodiments of the invention have been described. Nevertheless, it will be understood that various modifications may be made without departing from the spirit and scope of the invention. Accordingly, other embodiments are within the scope of the following claims.

1. A luminous display comprising
at least one panel of a transparent medium, said panel having two major surfaces surroundingly joined by at least one edge and having etched into at least one of its major surfaces lines comprising at least a portion of a design,
for each panel at least one light source disposed to inject light into the panel through at least one edge thereof whereby the etched lines scatter injected light and render said design or design portion visually perceptible to viewers.

2. The display according to claim 1 wherein said at least one light source is a low-voltage source.

3. The display according to claim 2 wherein the at least one light source comprises strip assemblies of LEDs.

4. The display according to claim 3 wherein said strip assemblies comprise chip-on-board (COB) LEDs of at least three different colors, whereby the injected color for each panel may be selected.

5. The display according to claim 1 any of claim 1 further including programmed or programmable electronic control means for varying at least one of the color, intensity or duration of on and off times of said at least one light source.

6. The display according to claim 1 wherein said at least one light source includes a reflector to direct light at the at least one minor panel side and wherein portions of minor panel sides not utilized for light injection have a reflective coating.

7. The display according to claim 5 comprising a stack of at least two transmissively separate panels each including a portion of the message and each having a separate light source.

8. The display according to claim 7 wherein an air gap separates adjacent panels in the stack.

9. The display according to claim 7 wherein said electronic control means separately controls the at least one light source for each panel.

10. The display according to claim 9 wherein said electronic control means varies color over time.
